(19) United States
(12) Patent Application Publication
(10) Pub. No.: US 2020/0279701 A1
(43) Pub. Date: Sep. 3, 2020

(54) Thermal Metal Oxide Varistor Circuit Protection Device

(71) Applicant: Dongguan Littelfuse Electronics Co., Ltd., Dongguan City, Guangdong Province (CN)

(72) Inventors: Wen Yang, Dongguan City (CN); Hailang Tang, Dongguan City (CN); Dong Yu, Dongguan City (CN)

(21) Appl. No.: 15/998,552

(22) PCT Filed: Feb. 15, 2016
(86) PCT No.: PCT/CN2016/073782

§ 371 Date: Aug. 15, 2018

(51) Int. Cl. H01H 9/32; H01C 7/12; H01H 37/76; H01H 61/02; H01H 85/048; H01H 85/30; H01H 85/36; H01H 9/16

(52) U.S. Cl. CPC H01H 9/32; H01C 7/126; H01H 37/761; H01H 61/02; H01H 2085/0275; H01H 85/306; H01H 85/36; H01H 9/16; H01H 2037/762; H01H 85/048

(57) ABSTRACT

A circuit protection device includes: a housing (102) defining a cavity (130); a metal oxide varistor (110) disposed within the cavity; a movable electrode (122) attached to a first side of the metal oxide varistor by a solder connection (140); an arc shield (114) disposed within the housing on the first side of the metal oxide varistor and adjacent to the movable electrode; and a spring (120) attached to the arc shield, wherein the arc shield is mechanically biased against the movable electrode along a surface direction parallel to the first side when the spring is in a compressed state. The device is easy to assemble in lower cost and provides fast response to overheating caused by a fault condition.

### TECHNICAL FIELD

Embodiments relate to the field of circuit protection devices. More particularly, the present embodiments relate to a surge protection device with a thermal disconnect system configured to provide fast response to overheating.

### DISCUSSION OF RELATED ART

Over-voltage protection devices are used to protect electronic circuits and components from damage due to over-voltage fault conditions. These over-voltage protection devices may include metal oxide varistors (MOVs) connected between the circuits to be protected and a ground line. MOVs have a unique current-voltage characteristic allowing them to be used to protect such circuits against catastrophic voltage surges. Often, these devices utilize thermal links where the thermal links can melt during an abnormal condition to form an open circuit. In particular, when a voltage larger than the nominal or threshold voltage is applied to the device, current flows through an MOV, resulting in the generation of heat. This heat causes the thermal link to melt. Once the link melts, an open circuit is created, preventing the over-voltage condition from damaging the circuit to be protected. However, these existing circuit protection devices do not provide an efficient heat transfer from the MOV to the thermal link, thereby delaying response times. Additionally, after an open circuit condition is established, arcing may take place between components in close proximity to one another. In addition, existing circuit protection devices are complicated to assemble, increasing manufacturing costs. Accordingly, improvements may be useful in present day circuit protection device employing metal oxide varistors.

### SUMMARY

Exemplary embodiments of the present disclosure are directed to a circuit protection device. In an exemplary embodiment, the circuit protection device may include a housing defining a cavity and a metal oxide varistor disposed within said cavity. The circuit protection device may further include a movable electrode attached to a first side of the metal oxide varistor by a solder connection, an arc shield disposed within the housing on the first side of the metal oxide varistor and adjacent the movable electrode, and a spring attached to the arc shield, wherein the arc shield is mechanically biased against the movable electrode along a surface direction parallel to the first side when the spring is in a compressed state.

In another exemplary embodiment, a circuit protection device includes a housing defining a cavity and a metal oxide varistor disposed within said cavity. The circuit protection device may further include an insulator pad disposed on a first side of the metal oxide varistor and a movable electrode disposed on the insulator pad and electrically connected to the metal oxide varistor. In addition, the circuit protection device may include an arc shield comprising an electrical insulator and being disposed within the housing on the insulator pad and adjacent the movable electrode; and a spring attached to the arc shield, wherein the arc shield is mechanically biased against the movable electrode along a surface direction parallel to the first side when the spring is in a compressed state.

### BRIEF DESCRIPTION OF THE DRAWINGS

FIG. 1A is a perspective view of a circuit protection device in accordance with an embodiment of the present disclosure.

FIG. 1B is a cut-away perspective view of the circuit protection device of FIG. 1A with a portion of the housing removed, according to an embodiment of the present disclosure.

FIG. 1C is a side cross-sectional view of the circuit protection device of FIG. 1A.

FIG. 1D is a cut-away perspective view a partially assembled circuit protection device according to embodiments of the disclosure.

FIG. 2A is a perspective view of an exemplary insulator pad according to embodiments of the disclosure.

FIG. 2B is a perspective view of components of a circuit protection device according to embodiments of the disclosure.

FIG. 2C is another perspective view of the components of a circuit protection device of FIG. 2B.

FIG. 2D is a bottom perspective view of the components of a circuit protection device of FIG. 2B.

FIG. 3A is a cut-away perspective view of a configuration of the circuit protection device of FIG. 1B during normal operation.

FIG. 3B is a cut-away perspective view of a configuration of the circuit protection device of FIG. 1B after actuation of a fault condition in accordance with an embodiment of the present disclosure.

### DESCRIPTION OF EMBODIMENTS

The present embodiments will now be described more fully hereinafter with reference to the accompanying drawings, where preferred embodiments are shown. These embodiments, however, may be embodied in many different forms and should not be construed as limited to the embodiments set forth herein. Rather, these embodiments are provided so this disclosure will be thorough and complete, and will fully convey the scope of the embodiments to those skilled in the art. In the drawings, like numbers refer to like elements throughout.

In the following description and/or claims, the terms “on,” “overlying,” “disposed on” and “over” may be used in the following description and claims. “On,” “overlying,” “disposed on” and “over” may be used to indicate two or more elements are in direct physical contact to one other. However, “on,”, “overlying,” “disposed on,” and over, may also mean two or more elements are not in direct contact with one another. For example, “over” may mean one element is above another element but not contact one another and may have another element or elements in between the two elements. Furthermore, the term “and/or” may mean “and”, may mean “or”, may mean “exclusive-or”, may mean “one”, may mean “some, but not all”, may mean “neither”, and/or may mean “both”, although the scope of claimed subject matter is not limited in this respect.

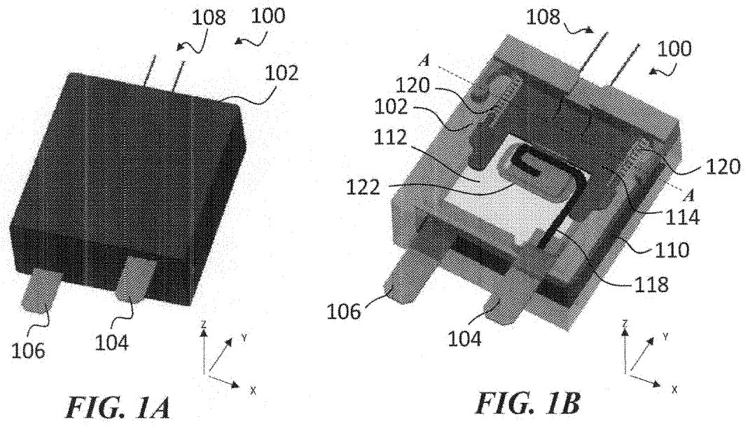

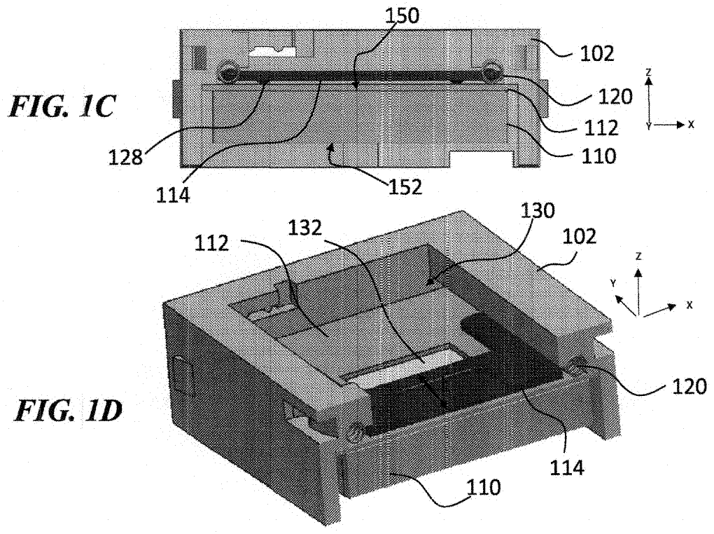

FIG. 1A to FIG. 1D illustrate various views of a circuit protection device 100 according to embodiments of the disclosure. In particular, FIG. 1A is a perspective view of the circuit protection device 100 after assembly, not showing internal components. The circuit protection device 100 as shown includes a first terminal, shown as a first contact lead 104 and a second contact lead 106. The first contact lead 104 and second contact lead 106 extend outside a housing 102, where the housing 102 may be an insulating material such as a known plastic material or other polymeric material. As discussed below, the first contact lead 104 and second contact lead 106 may extend inside the housing 102 to form electrical contact with a metal oxide varistor (MOV). The circuit protection device 100 may also include a pair of electrically conductive indicator pins shown as the indicator pins 108. In various embodiments the indicator pins may be electrically connected to an electrical indicator (not shown) external to the circuit protection device 100, such as a light or other device.

FIG. 1B is a cut-away perspective view of the circuit protection device 100 with a portion of the housing 102 removed. The circuit protection device 100 may include a metal oxide varistor 110, where the metal oxide varistor 110 may have a flat shape, such as a rectangular disc or a circular disk. The embodiments are not limited in this context. The circuit protection device 100 may include an insulator pad 112 disposed on the first side (upper side parallel to the X-Y plane in FIG. 1B) of the metal oxide varistor 110 as shown. The insulator pad 112 may be a printed circuit board (PCB) in various embodiments. In the present embodiments, a PCB may comprise a known material used for forming the body of a printed circuit board. The PCB may be planar in shape and may have any appropriate thickness for use in a circuit protection device. In various embodiments, the PCB may further include features such as openings or electrically conductive material disposed on the surface of the PCB or in openings extending through the PCB, for example.

As further shown in FIG. 1B, the circuit protection device 100 may include a movable electrode 122 disposed on the insulator pad 112, where the operation of movable electrode 122 is discussed below. The circuit protection device 100 may further include a flexible conductive wire 118 connected to the movable electrode 122 on a first end and connected to the first contact lead 104 on a second end. In various embodiments, the first contact lead 104, second contact lead 106 and/or flexible conductive wire 118 may be composed of a metal such as copper. The circuit protection device 100 may further include an arc shield 114 disposed within the housing 102 on the first side of the metal oxide varistor 110 and adjacent the movable electrode 122. The operation of the arc shield 114 is also described below. In addition, the circuit protection device may include a spring 120, or a plurality of springs, as shown in FIG. 1B. The spring(s) 120 may be attached to the arc shield 114, or may otherwise engage the arc shield 114 as shown. As illustrated in FIG. 1B, as assembled, the spring 120 may be in a compressed state. As detailed below, this compressed state may cause the arc shield 114 to be mechanically biased against the movable electrode 122 along a surface direction parallel to the first side of the metal oxide varistor 110 (i.e., along the Y-axis of the Cartesian coordinate system shown).

Turning now to FIG. 1C there is shown a side-cross sectional view along the direction A-A (in the X-Z plane) for the circuit protection device 100. As illustrated, the metal oxide varistor 110 is disposed within the housing 102 and may have a first side 150 supporting the insulator pad 112, as well as a second side 152. In plan view (X-Y plane) the metal oxide varistors 110 may be rectangular in shape, in accordance with the shape of the housing 102, in this embodiment. As will be appreciated, alternative shapes of metal oxide varistor 110 may also be employed and housing 102 may likewise have an alternative shape to accommodate the particular shapes of a metal oxide varistor 110. The insulator pad 112 may be disposed directly on the metal oxide varistor 110 as further shown in the cut-out perspective view of FIG. 1D.

The insulator pad 112, such as a PCB, may function not only to insulate the moveable electrode and MOV but also as a protection shield to the mechanical moving system, since in the event of a high short circuit current, a possible flame generated from an MOV may damage the disconnect system if no shield is present.

Additionally, the arc shield 114 may be disposed over a portion of the insulator pad 112 as shown. In particular, the length L of the arc shield along the direction parallel to the Y-axis is less than the size of the cavity 130 along the Y-axis. As detailed below this relatively smaller size of the arc shield 114 allows displacement of the arc shield 114 along the surface of the insulator pad 112 in the direction parallel to the Y-axis, facilitating the ability to prevent arcs during a fusing event. In some embodiments, as further shown in FIG. 1C, the arc shield 114 may include protrusions 128 The protrusions 128 may form points of contact to the surface of insulator pad 112, facilitating movement of the arc shield 114 with respect to insulator pad 112 by providing less surface area for friction between arc shield 114 and insulator pad 112. As also illustrated in FIG. 1D, the insulator pad 112 may include an opening 132, where the opening 132 may accommodate a solder connection, as discussed below. In the configuration of FIG. 1D, the arc shield 114 is positioned toward one side of the cavity 130, opposite to the side where the first contact lead 104 and second contact lead 106 enter the cavity 130 (See FIG. 1B). After assembly of the circuit protection device 100 for normal operation, the opening 132 of the insulator pad 112 is situated so as to not be covered by the arc shield 144, as shown in FIG. 1D. This opening 132 allows a solder connection to be formed between the movable electrode 122 and metal oxide varistor 110.

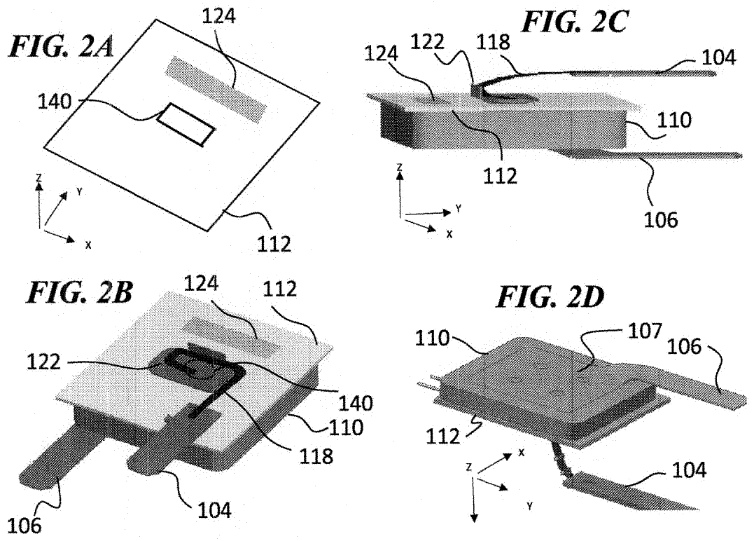

FIG. 2A is a perspective view of an insulator pad 112 according to embodiments of the disclosure. In this embodiment, the insulator pad may be a PCB having a known composition and structure. The shape of the insulator pad 112 may be designed according to the shape of a housing, such as a rectangular shape, or other shape. As illustrated, the insulator pad 112 includes a conductive contact pad 124 whose function has been described above, as well as an opening 132.

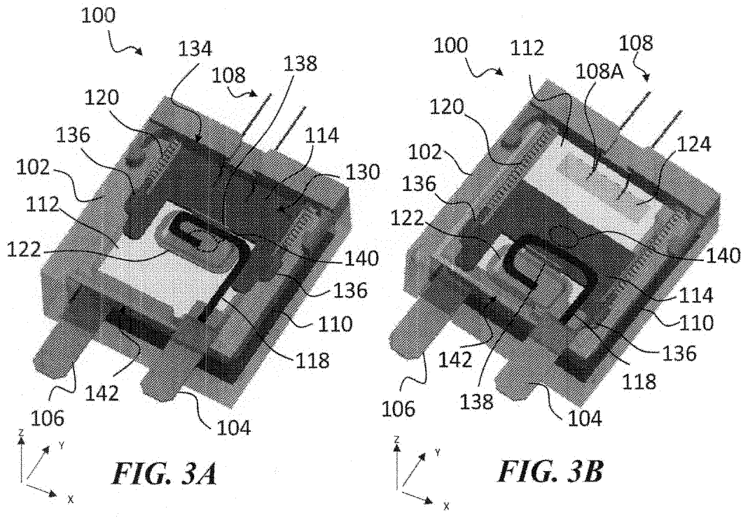

FIG. 2B is a perspective view of components of a circuit protection device without a housing in accordance with an embodiment of the present disclosure. The components shown in FIG. 2A may be used in the circuit protection device 100, for example. FIG. 2C is another perspective view of the components of a circuit protection device of FIG. 2B. In particular, FIG. 2B illustrates the arrangement of metal oxide varistor 110, insulator pad 112 and first contact lead 104 and second contact lead 106. The insulator pad 112 is disposed on the metal oxide varistors 110 and the movable electrode 122 disposed on the insulator pad 112. The movable electrode 122 is mechanically fixed to the metal oxide varistor 110 by virtue of the solder connection 140. As particularly shown in FIG. 2C the first contact lead 104 extends over the insulator pad 112, forming a gap along the direction parallel to the Z-axis, and does not contact the insulator pad 112. The connection of the movable electrode 122 to the first contact lead 104 via flexible conductive wire 118 facilitates movement of the movable electrode 122. In particular, as discussed below with respect to FIG. 3A and FIG. 3B, when a fault condition occurs and the movable electrode 122 is displaced away from the side 134, the flexible conductive wire 118 may provide little mechanical resistance to movement of the movable electrode 122.

FIG. 2D presents a bottom perspective view of the components of a circuit protection device of FIG. 2B. In this example, the second contact lead 106 may terminate in a conductive pad 107 that is electrically connected to the metal oxide varistor 110.

Turning now to FIG. 3A and FIG. 3B, there is shown an example of operation of the circuit protection device 100 according to embodiments of the disclosure. In FIG. 3A a cut-away perspective view of the configuration of the circuit protection device 100 during normal operation is shown. As shown, the arc shield 114 is positioned toward a side 134 of the cavity 130, and includes side portions 136, where a side portion 136 engages a spring 120, located on either side of the arc shield 114. When positioned toward the side 134, the arc shield 114, via the side portions 136, places the spring 120 in a compressed state. As further shown in FIG. 3A, the movable electrode 122 abuts the arc shield 114. In some embodiments, the movable electrode 122 may include a protrusion such as a tab 138, engaging the arc shield 114, and preventing the arc shield 114 from moving toward side 142. In the configuration of FIG. 3A, the movable electrode 122 is connected to the metal oxide varistor 110 via a solder connection 140 (shown as dashed feature) extending through the opening 132 of the insulator pad 112 (see FIG. 1D). The solder connection 140 may be composed of a conventional low temperature solder in various embodiments, such as a low melting temperature alloy including SnIn, SnBi, or other alloy.

Because the movable electrode 122 prevents the arc shield 114 from moving, while the spring 120 is in a compressed state, the arc shield 114 is mechanically biased against the movable electrode 122 along the Y-axis. In other words, the arc shield 114 exerts a mechanical force against the movable electrode 122 tending to displace the movable electrode 122 toward the side 142.

In accordance with various embodiments, the metal oxide varistor 110 may be a conventional metal oxide varistor (MOV) made from any appropriate composition or process. An MOV is a voltage sensitive device designed to heat up when the voltage applied across the device exceeds a rated voltage. By the way of background, MOVs may be comprised of zinc oxide granules or similar material, where the granules are sintered together to form a disc. A given zinc oxide granule may be a highly electrically conductive material, while the intergranular boundary is formed of other oxides and is highly resistive. Just at those points where zinc oxide granules meet does sintering produce a ‘microvaristor’ comparable to symmetrical Zener diodes. The electrical behavior of a metal oxide varistor results from the number of microvaristors connected in electrical series or in parallel. The sintered body of an MOV also explains its high electrical load capacity permitting high absorption of energy and thus, exceptionally high surge current handling capability.

Under conventional operation, the metal oxide varistor 110 may experience a voltage across the metal oxide varistor 110 below a threshold voltage of the metal oxide varistors 110, where the threshold voltage corresponds to a voltage where metal oxide varistor 110 becomes electrically conducting. Thus, when voltage is below the threshold voltage, the metal oxide varistor 110 remains as an electrical insulator. Conversely, when voltage across the metal oxide varistor 110 exceeds the threshold voltage, the metal oxide varistor may become electrically conductive. For example, when a voltage surge condition occurs, where the voltage exceeds the threshold voltage for a sufficient duration, the metal oxide varistor 110 changes from a non-conductive state to the conductive state and current flows between first contact lead 104 and second contact lead 106. As the voltage surge continues, the gaps and boundaries between the zinc oxide granules within the metal oxide varistor 110 are not wide enough to block current flow, and thus the metal oxide varistor 110 becomes highly conductive. This conduction generates heat, causing melting of solder at the solder connection 140. The melting of the solder, in turn, releases movable electrode 122 from mechanical restraint formerly provided by the bonding of the movable electrode to solid solder in the solder connection 140.

Once mechanical constraint is released by melting of solder in the solder connection 140, the mechanical bias provided by arc shield 114 may displace the movable electrode 122 along the Y-axis toward the side 142. This displacement is illustrated in FIG. 3B FIG. 3B, showing a cut-away perspective view of a configuration of the circuit protection device 100 after actuation of a fault condition. As illustrated, the spring 120 is now in an extended state, having released at least some of the potential energy stored in the compressed state shown in FIG. 3A. The movable electrode 122 is now disposed toward the side 142, while the arc shield 114 is disposed over the region of the solder connection 140. Movement of the movable electrode 122 from the configuration of FIG. 3A to the configuration of FIG. 3B may be facilitated by the tab 138, providing a portion of movable electrode 122 easily engaged by the arc shield 114. Because the arc shield is displaced over the solder connection 140, any arcing otherwise produced by the high voltage condition between the metal oxide varistor 110 and movable electrode 122, flexible conductive wire 118, or first contact lead 104 is suppressed.

While it may be possible to solder a movable electrode directly to a metal oxide varistor, for example, if the metal oxide varistor is coated with insulation material, e.g. epoxy, etc, such a design may not withstand a high short circuit current during overvoltage events as well as designs using the insulator pad 112 of the aforementioned embodiments. Accordingly, the embodiments employing an insulator pad 112 may provide better protection against flame damage caused by a high short circuit current in compared to a configuration in which the movable electrode and arc shield are directly adjacent a metal oxide varistor.

In various embodiments, the indicator pins 108 may be configured to provide an indication of a fault condition. As shown in FIG. 3A and FIG. 3B the indicator pins may have interior ends extending within the housing 102 and exterior ends extending outside of the housing 102. In the configuration of FIG. 3A, the indicator pins may extend over the arc shield 114 when the movable electrode 122 is connected to the solder connection 140 as shown. In particular, the interior ends 108A (see FIG. 3B) of the indicator pins 108 may be mechanically biased downwardly along the Z-axis toward the arc shield 114. Because the arc shield 114 is an electrical insulator, the indicator pins 108, even if contacting the surface of the arc shield 114, are not electrically connected to one another and accordingly do not complete an electrical path. During a fault condition where the arc shield 114 is displaced away from the side 134, a portion of the insulator pad 112 adjacent the side 134 is exposed. In various embodiments, the insulator pad 112, such as a PCB, may include on the outer surface an electrically conductive contact pad 124, located towards the side 134 as shown. This location allows the indicator pins 108, being mechanically biased toward the insulator pad 112, to form electrical contact with the electrically conductive contact pad 124 when the movable electrode 122 is disconnected from the solder connection 140 and the arc shield is accordingly displaced toward the side 142. The indicator pins 108 may accordingly complete an electrical path forming part of a circuit including an indicator light (not shown) or other device, and accordingly providing an indication of a fault condition.

In summary, the circuit protection devices of the present embodiments provide a novel configurations of components for response to an overvoltage conditions. The circuit protection devices are designed to provide a thermally driven disconnect system harnessing the heating of an MOV under a fault condition. Among other advantages, the present embodiments provide a device easy to assemble, providing lower cost. The circuit protection devices also provide fast response to overheating caused by a fault condition. In some embodiments, up to 200 kA may be passed without use of additional protection. The circuit protection devices further provide a safe disconnecting device free from arcing issues in a compact package. In addition, a convenient fault or isolation indication is provided.

While the present embodiments has been disclosed with reference to certain embodiments, numerous modifications, alterations and changes to the described embodiments are possible without departing from the sphere and scope of the present embodiments, as defined in the appended claims. Accordingly the present embodiments are not to be limited to the described embodiments, but have the full scope defined by the language of the following claims, and equivalents thereof.

What is claimed is:

1. A circuit protection device comprising:
a housing defining a cavity;
a metal oxide varistor disposed within said cavity;
a movable electrode attached to a first side of the metal oxide varistor by a solder connection;
an arc shield disposed within the housing on the first side of the metal oxide varistor and adjacent the movable electrode; and
a spring attached to the arc shield, wherein the arc shield is mechanically biased against the movable electrode along a surface direction parallel to the first side when the spring is in a compressed state.

2. The circuit protection device of claim 1, wherein the spring is in a compressed state when the movable electrode is disposed over the solder connection, and wherein when the arc shield is disposed over the solder connection the spring is in an extended state.

3. The circuit protection device of claim 1, further comprising a first contact lead, the first contact lead being electrically connected to the movable electrode and a second contact lead, the second contact lead being electrically attached to a second side of the metal oxide varistor, the second side being opposite the first side.

4. The circuit protection device of claim 3 further comprising a flexible conductive wire connected between the first contact lead and the movable electrode.

5. The circuit protection device of claim 1, wherein upon occurrence of a fault condition where voltage exceeds a threshold voltage of the metal oxide varistor, the metal oxide varistor is configured to transmit electrical current adequate to heat the solder connection to release the movable electrode, wherein the spring displaces the arc shield over the solder connection and displaces the movable electrode away from the solder connection along the surface direction.

6. The circuit protection device of claim 1, further comprising an insulator pad disposed on the first side of the metal oxide varistor.

7. The circuit protection device of claim 6, wherein the insulator pad comprises a printed circuit board (PCB), and wherein the arc shield and movable electrode are disposed on the PCB.

8. The circuit protection device of claim 7, further comprising a first contact lead, the first contact lead being electrically connected to the movable electrode, wherein the first contact lead extends through the housing above the PCB and does not contact the PCB.

9. The circuit protection device of claim 8, further comprising a flexible conductive wire connected to the movable electrode on a first end and connected to the first contact lead on a second end.

10. The circuit protection device of claim 1, further comprising:
a printed circuit board (PCB) disposed on the first side of the metal oxide varistor, the printed circuit board comprising:
an electrically insulating body;
an electrically conductive contact pad disposed on a first region of the PCB; and
an opening extending between the metal oxide varistor and the movable electrode.

11. The circuit protection device of claim 10, wherein the arc shield comprises an electrical insulator, the circuit protection device further comprising:
a pair of electrically conductive indicator pins,
wherein the pair of electrically conductive indicator pins comprise interior ends extending within the housing and exterior ends extending outside of the housing,
wherein the interior ends of the electrically conductive indicator pins extend over the arc shield when the movable electrode is connected to the solder connection, and wherein the interior ends are in electrical contact with the electrically conductive contact pad when the movable electrode is disconnected from the solder connection.

12. A circuit protection device comprising:
a housing defining a cavity;
a metal oxide varistor disposed within said cavity;
an insulator pad disposed on a first side of the metal oxide varistor;
a movable electrode disposed on the insulator pad and electrically connected to the metal oxide varistor;
an arc shield comprising an electrical insulator and being disposed within the housing on the insulator pad and adjacent the movable electrode; and
a spring attached to the arc shield, wherein the arc shield is mechanically biased against the movable electrode along a surface direction parallel to the first side when the spring is in a compressed state.

13. The circuit protection device of claim 12, further comprising a solder connection extending between the metal oxide varistor and the movable electrode via an opening in the insulator pad.

14. The circuit protection device of claim 12, further comprising:
a first contact lead, the first contact lead being electrically connected to the movable electrode;
a second contact lead electrically attached to a second side of the metal oxide varistor, the second side being opposite the first side; and
a flexible conductive wire connected between the first contact lead and the movable electrode.

15. The circuit protection device of claim 12, the insulator pad comprising:
an electrically insulating body;
an electrically conductive contact pad disposed on a first region of the insulator pad; and
an opening extending between the metal oxide varistor and the movable electrode.

16. The circuit protection device of claim 15, further comprising:
a pair of electrically conductive indicator pins,
wherein the pair of electrically conductive indicator pins comprise interior ends extending within the housing and exterior ends extending outside of the housing,
wherein the interior ends of the electrically conductive indicator pins extend over the arc shield when the movable electrode is connected to the solder connection, and wherein the interior ends are in electrical contact with the electrically conductive contact pad when the movable electrode is disconnected from the solder connection.
